(19) United States
(12) Patent Application Publication
(10) Pub. No.: US 2012/0180874 A1
(43) Pub. Date: Jul. 19, 2012

(54) DEVICE AND METHOD TO PREVENT IMPROPER FLUID MIXING RATIOS IN TWO COMPONENT MATERIALS

(76) Inventor: Robert Ray Mellette, Nederland, CO (US)

(21) Appl. No.: 13/350,386

(22) Filed: Jan. 13, 2012

Related U.S. Application Data
(60) Provisional application No. 61/432,306, filed on Jan. 13, 2011.

(51) Int. Cl. G05D 11/00

(52) U.S. Cl. 137/3; 137/88

(57) ABSTRACT

The present invention relates to an apparatus and method for maintaining a fluid mixing ratio. The apparatus according to various embodiments prevents a fluid flow imbalance between two proportionate fluid streams based on a pressure difference, and may be configured to alert the user and/or stop the fluid flow in the event of a fluid flow imbalance. The apparatus is formed such that two plunger components engage a shuttle piston, the shuttle piston configured to move one or more plunger components given a selectable fluid flow imbalance.

### CROSS-REFERENCE TO RELATED APPLICATIONS

This application claims the benefit of U.S. Provisional Patent Application No. 61/432,306, entitled “DEVICE TO PREVENT IMPROPER FLUID MIXING RATIOS IN TWO COMPONENT MATERIALS,” filed on Jan. 13, 2011, the entire contents of which are incorporated herein by reference in its entirety for all purposes.

### FIELD OF THE INVENTION

This disclosure relates to fluid mixing, and more specifically to an apparatus and method for maintaining a fluid mixing ratio.

### BACKGROUND OF THE INVENTION

A variety of applications exist in the chemical, adhesives, and coatings industries wherein a liquid product is formulated by mixing two or more component liquids in a specific volumetric ratio. For a general background on fluid mixing and some of the tools and apparatus used involving fluid mixing, see U.S. Pat. No. 3,763,876 issued to Freeman et al (“Freeman”) on Oct. 9, 1973, the entire disclosure of which is incorporated herein by reference in its entirety. In addition, further background on fluid mixing is found in U.S. Pat. No. 3,045,925 to Giangualano (“Giangualano”) issued Jul. 24, 1962, the entire disclosure of which is incorporated herein by reference in its entirety.

A specific example of a fluid mixing application relating to the current invention is found in the mixing of two component coating materials that must be combined in a specific volumetric proportion of base material and catalyst material before being applied (typically by a spray application process) to the product. While for small-batch production the base and catalyst components may be pre-mixed and applied using conventional single component spray equipment, this method is not practicable for large volume production or for coating formulations with rapid cure times. In such cases, it is more expedient to utilize automatic mixing systems which combine the components of the coating in the proper proportions just prior to delivery to the spray gun.

A concern for users of automatic mixing equipment is the possibility of the proportions (mix ratio) between the base and catalyst components of the coating material exceeding the tolerance limits for the proportions of those components due, for example, to equipment malfunction or unnoticed depletion of the material supply. Some monitoring systems are commercially available that utilize flow meters to measure and compare volumetric delivery of each component and alert the operator if the mix ratio deviates from acceptable limits, but these devices are prohibitively costly for smaller production operations. For example, U.S. Patent Publication No. 2009/0194562 to Kessler et al. (“Kessler “) published Aug. 6, 2009 describes a metering apparatus for flowable preparations and includes a metering unit with an energy source, a control unit and a sensor unit. Kessler is incorporated by reference in its entirety.

The prior art typically combines and mixes two component fluids or liquids with no or little dynamic control of the mixing ratio of the two fluids. For example, U.S. Pat. No. 4,522,789 to Kelly et al. (”Kelly I″) issued Jun. 11, 1985 and U.S. Pat. No. 4,548,652 to Kelly et al. (“Kelly II”) issued Oct. 22, 1985 discloses a system and method, respectively, of operating for mixing and dispensing two liquid components, one chemically stable when maintained in isolation and the other chemically reactive when combined with the first component. The system includes separate liquid storage containers and pumps for delivering each of the liquids through a common mixing manifold, and from there to a dispensing apparatus. A further pump in one of the containers delivers liquid through a valved, closed loop subsystem back to the container, the closed loop having an entry point for connection to the dispensing apparatus. A further valve controls the flow of the other liquid component to the dispensing apparatus, whereby the conduits leading to the dispensing apparatus may be purged of mixed liquid components, diluted, and returned to the one storage container. There is no attempt to control the fluid balance or mixing ratio during operation. Both Kelly I and Kelly II are incorporated by reference in their entireties.

Traditional fluid mixing devices are configured to statically set the fluid mixing ratio or fluid proportions through mechanical or hydro-mechanical means. For example, U.S. Pat. No. 5,425,968 to Larson (“Larson”) issued Jun. 20, 1995 discloses a device for applying a multi-component coating composition onto a substrate. The device separately transports one fluid component under pressure to a proportioning device which provides a controlled ratio of the fluid components. The components of the coating composition are then mixed and coated onto the substrate at ambient temperature or, to accelerate curing, at moderate temperatures. In Larson, a particular fluid flow volume is determined by cylinder diameter, and thus the volumetric displacement of each piston movement determines the ratio of the fluid components. Larson is incorporated by reference in its entirety.

U.S. Pat. No. 5,011,292 to Trapasso et al. (“Trapasso”) issued Apr. 30, 1991 discloses an apparatus for pumping, mixing and dispensing two liquids including a conduit for tapping a remotely located container containing a first concentrated liquid, such as methyl alcohol. A housing contains a second liquid for diluting the first liquid and a pump for pumping the two liquids at equal rates into a static mixing apparatus. The amount of first liquid entering the mixer may be decreased as desired via a needle valve located on a conduit leading back to the remotely located container. The mixer includes an internal cavity having a plurality of 90 degree hollow elbow joints randomly positioned therein such that the two liquids pass through and combine into a resultant mixture. The mixture may be dispensed to a second remote location as desired. Trapasso is incorporated by reference in its entirety.

Some fluid mixing systems provide mechanisms to stop one or more component feed streams in the event of depletion. For example, U.S. Pat. No. 6,036,057 to Pouliatine (“Pouliatine”) issued March 14, 2000 discloses a proportioning system employing an actuator which engages a pair of cylinders and pistons. By changing the diameter and/or stroke of the pistons, the mix ratio of two dispensed fluids changes. Further, by changing the pivot point of the actuator, the stroke length can be changed. Pouliatine's proportioning system also includes a check valve safety mechanism which prevents a concentrated fluid from being dispensed should the reservoir of diluting fluid be depleted. Pouliatine is incorporated by reference in its entirety.

U.S. Pat. No. 5,439,141 to Clark et al. (“Clark”) issued Aug. 8, 1995 discloses a manifold for use with a hand held pump spray device allowing the spray head to draw simultaneously from two reservoirs containing different fluids such that the spray heads raise a mixture of the two fluids in a predetermined ratio. The manifold includes at least one ball check valve arrangement in the suction line to the chemical concentrate reservoir, the ball check valve being normally biased to a closed position. The check valve prevents the pumping of the concentrate when the diluent reservoir is spent and further prevents cross contamination between the fluids in the two reservoirs due to syphoning. Clark is incorporated by reference in its entirety.

The prior art includes some devices that electronically control mixing ratios. For example, U.S. Pat. No. 4,832,499 to Fiorentini (“Fiorentini”) issued May 23, 1989 discloses an apparatus for metering and feeding reactive chemical fluid components to a high pressure mixing head. The apparatus comprises transfer cylinders whose control unit is fed with hydraulic fluid from a single source of constant pressure. A proportional servo valve computer-controlled in relation to the rate of flow of the components keeps the pressure and flow of the components to be mixed constant. Fiorentini is incorporated by reference in its entirety.

Some mixing devices attempt to smooth fluid flow perturbations while maintaining a set mixing ratio. For example, U.S. Pat. No. 5,178,178 to Hartl (“Hartl”) issued Jan. 12, 1993 discloses a valve assembly for controlling pressurized inputs from two separate fluid sources. The Hartl device isolates the fluid sources and buffers short-term fluctuations in fluid flow. A high pressure chamber is provided which employs a fluid-impervious flexible membrane to separate the two fluid chambers. A ball valve with a movable member is positioned in an inlet port in each channel portion. A pressure differential in the chamber portions deflects the diaphragm to bear against the movable member in the lower pressure chamber portion, closing the valve for this chamber portion before the pressure is sufficient to result in any backflow. The membrane also deflects when there are momentary breaks in the flow from one source to temporarily buffer flow from the other source, thus maintaining a substantially uniform mix ratio. Hartl is incorporated by reference in its entirety.

The prior art mixing devices do not adequately provide a reliable, effective, cost-effective means to automatically prevent an improper fluid mixing ratio, such as that required when mixing a base and catalyst fluid components. Therefore, there is a long-felt need for an apparatus and method for maintaining a fluid mixing ratio and preventing improper fluid mixing ratios based on a pressure difference between two fluid streams. The present invention solves these needs by monitoring fluid pressure of two fluid streams and detecting a selectable imbalance between those fluid streams. In one embodiment of the invention, the user is alerted to the fluid imbalance and/or the fluid flow is stopped. The apparatus is formed such that two plunger components engage a shuttle piston, the shuttle piston configured to move one or more plunger components given a selectable fluid flow imbalance. In this manner, the device is automatic and/or is enabled through hydromechanical means.

### SUMMARY OF THE INVENTION

Certain embodiments of the present disclosure relate to an apparatus and method for maintaining a fluid mixing ratio. The apparatus according to various embodiments prevents a fluid flow imbalance between two proportionate fluid streams based on a pressure difference, and may be configured to alert the user and/or stop the fluid flow in the event of a fluid flow imbalance. The apparatus is formed such that two plunger components engage a shuttle piston, the shuttle piston configured to move one or more plunger components given a selectable fluid flow imbalance. Other embodiments and alternatives to this device are described in greater detail below.

In one application of the device, a first fluid stream is supplied from a first pump and a second fluid stream is supplied from a second pump. Both of the fluid streams, operating at substantially the same pressure, engage the device and subsequently are mixed. For example, the first fluid material is a base fluid and the second fluid is a catalyst fluid material which, after engaging the device, are combined to form a catalyzed material and supplied to a spray gun.

By way of providing additional background, context, and to further satisfy the written description requirements of 35 U.S.C. §112, the following references are incorporated by reference in their entireties for the express purpose of explaining the nature of the fluid mixing and to further describe the various tools and other apparatus commonly associated therewith: U.S. Pat. No. 7,464,766, which describes a self-metering automatic nozzle and U.S. Pat. No. 3,763,876, which describes a fluid valve and mixing assembly.

The phrase “device” and/or “apparatus” and/or “mix guard” is used herein to indicate the invention device. The phrase “automatic” refers to a device's ability to automatically adjust and/or adapt itself to maintain and/or monitor a specified condition or state. The phrase “removably attached” and/or “detachable” is used herein to indicate an attachment of any sort that is readily releasable. The phrase “steady state” means routine or regular operation and not transitory states such as start-up, shut-down, locked-out or calibration. The phrase “fluid” and/or “fluids” means liquids and gases, as well as mixtures thereof and mixtures of such with solids. The phrase “alert” and/or “alarm” and/or “indication” refer to any means to communicate to and/or with a user.

In a preferred embodiment, the device comprises a housing which is generally of rectilinear geometry and comprises a device top and bottom, device face and back, and device right side and left side.

The device further comprises a first plunger and a second plunger, each of which are engaged with a shuttle piston at shuttle piston conical section. The first plunger includes a first plunger proximal end, a first plunger distal end and a poppet air shut-off valve. A first plunger axial axis is formed between the first plunger proximal end and first plunger distal end. The first plunger is configured to contact a first plunger spring, the first plunger spring configured to fit around the exterior of the first plunger. In one embodiment of the invention, the first plunger spring is substantially co-axial with the first plunger. The first plunger spring is configured to impart a substantially axial force to the first plunger so as to enable substantially constant contact or communication between the first plunger proximal end and the shuttle piston conical section. Similarly, the second plunger includes a second plunger proximal end and a second plunger distal end. The second plunger is configured to contact a second plunger spring, the second plunger spring configured to fit around the exterior of the second plunger. In one embodiment of the invention, the second plunger spring is substantially co-axial with the second plunger. A second plunger axial axis is formed between the second plunger proximal end and second plunger distal end. The second plunger spring is configured to impart a substantially axial force to the second plunger so as to enable substantially constant contact or communication between the second plunger proximal end and the shuttle piston at the shuttle piston conical section. In one embodiment of the invention, the first plunger and a second plunger are substantially coaxial. The shuttle piston conical section is symmetrical about a plane perpendicular to the midpoint of the axial centerline of the shuttle piston.

In one embodiment of the invention, the shuttle piston operates along an axis that is substantially perpendicular to at least one of the operating axis of first plunger and second plunger. A shuttle piston axial axis is formed between the shuttle piston left side and shuttle piston right side. The shuttle piston operates within a cylindrical bore contained within the device housing, with device right side seal and device left side seal, therein forming two adjacent chambers, device right side chamber and device left side chamber that may be pressurized. The shuttle piston left side substantially resides in the device left side chamber, and the shuttle piston right side substantially resides in the device right side chamber. The device also comprises unpressurized cavities adjacent to the shuttle piston. The shuttle piston is thus configured to move axially.

In one embodiment, each of the first plunger and second plunger are able to move along their respective axial axes. When the first plunger moves vertically upwards toward the device top, the first plunger spring imparts an opposing force that urges the first plunger in the opposite direction, that is, downward and toward the shuttle piston. In contrast, when the second plunger moves vertically downwards toward the device bottom, the second plunger spring imparts an opposing force that urges the second plunger in the opposite direction, that is, upward and toward the shuttle piston. When the shuttle piston moves along its axial axis from its steady state and/or centered nominal position, either toward the device left side chamber or toward the device right side chamber, one or more of first plunger and second plunger move vertically away from the shuttle piston as each of the first plunger and second plunger engage a section of the shuttle piston conical section of increased radius. Stated another way, a hemispherical first plunder proximal end engages the upper shuttle piston conical section of the shuttle piston such that any movement of the shuttle piston along its longitudinal (axial) axis in either direction will cause the first plunger to rise along the surface of the upper conical section and be forced away from the longitudinal (axial) axis of the shuttle piston. The rate and magnitude of this movement can be changed as desired by modifying the included angle and diameter of the conical section of the shuttle piston. Further, the movement of the first plunger can be utilized to actuate a valve or switch to alert the operator user or to stop the equipment upstream and/or downstream of the device.

In one embodiment, a poppet-style (and/or mushroom-style) air shut-off valve is formed as a part of the first plunger such that axial movement of the shuttle piston due to a pressure differential between device right-side chamber and device left-side chamber is sufficient to move the first plunger and cause the poppet air shut-off valve to close. The poppet air shut-off valve is in-line with the one or more of device right-side port and device left-side port. Therefore, when the poppet air shut-off valve closes, the first air pressure and the second air pressure of the respective device right side port and device left side port are no longer equal, the two ports are no longer in fluid communication and the air flow stops, thus causing the motor to stop. When the poppet air shut-off valve moves to its closed position, the inlet air pressure (from one or more of device right-side port and/or device left-side port) exerts enough force on the bottom of the poppet air shut-off valve that the poppet air shut-off valve will remain closed until the poppet air shut-off valve is manually reset by a user. The poppet air shut-off valve may be manually reset through engagement of the device top upper knob, for example, by pushing the device top upper know vertically downwards.

The second plunger, diametrically opposed to the first plunger along the shuttle piston, creates additional centering force to the shuttle piston thereby further resisting axial (that is, longitudinal) movement of the shuttle piston, in turn increasing the threshold value of pressure differential between device left-side chamber and device right-side chamber below which the shuttle piston will not move. This threshold value is established by the combined spring force applied to the first plunger and the second plunger and the diameter of the shuttle piston.

Generally, the device is in fluid communication with a first fluid through device bottom right side pressure port and a second fluid through device left side pressure port. The first fluid maintains a nominal pressure one or first pressure, and the second fluid maintains a nominal pressure two or second pressure. The nominal pressure maintained in device right side chamber, which is in fluid communication with first fluid, is the same as that of first fluid. Similarly, the nominal pressure maintained in device left side chamber, which is in fluid communication with the second fluid, is the same as that of second fluid. When in steady-state and/or nominal operation, the first fluid and the second fluid are at substantially the same pressure, and thus each of the device right side chamber and the device left side chamber are at the same pressure and exert a substantially equal and opposite force against the shuttle piston right side and the shuttle piston left side, respectively, and the shuttle piston maintains a centered or nominal position substantially centered about the device vertical centerline and each of the first plunger and second plunger maintain a nominal position. However, when a predetermined and selectable pressure differential between the first fluid and the second fluid exists (and thus a pressure differential exists between the device right side chamber and the device left side chamber), the shuttle piston will traverse along its axial axis, which in turn will move the respective proximal ends of each of first plunger and second plunger vertically and away from the center area of the device as described above. The vertical movement of the first plunger and second plunger provide a means to alert the user and/or stop the fluid flow of the fluid flow imbalance event.

In one embodiment of the invention, the device comprises a device right side port and device left side port. One or more of the device right side port and device left side port are in communication with an air motor. The device right side port provides a first air pressure and the device left side port provides a second air pressure. During nominal or steady-state operation, the first air pressure and the second air pressure are substantially equal and the device right side port and device left side port are in fluid communication.

In another embodiment, the device may be configured in a locked-out configuration state. This locked-out state is particularly useful to prevent unwanted actuation of the poppet air shut-off valve and subsequent stoppage of external equipment during operational modes. The locked-out state would be useful during, for example, pump priming or system flushing or any situation that requires or causes unbalanced pressure between the two to-be-mixed fluids (such as a base and catalyst). In one embodiment of the locked-out configuration of the device, the poppet air shut-off valve stops flow between device right-side port and device left-side port and one or more of the device top pin one and device top pin two prevent movement of first plunger and lock the first plunger such that the first plunger is not engaged with the shuttle piston. In this condition, the fluid pressures from device right side pressure port and device left side pressure port are not subject to monitoring by the device. This state is a transitory state, that is, not a steady state, and is useful, for example, during start-up, shut-down, maintenance, cleaning and calibration.

In one embodiment of the device, the device top upper knob engages a device top lower body knob and a device top upper set screw. The device top lower body knob engages a device top lower set screw. The device top lower body knob engages an air valve body, which in turn engages a device top o-ring four, a device top o-ring three and device top o-ring two. The air valve body and o-rings engage the first plunger distal end. Below, or nearer the device housing, a first plunger spring fits over the first plunger. The first plunger comprises a poppet air shut-off valve and a first plunger proximal end. The first plunger proximal end engages a poppet guide. The poppet guide engages a device top o-ring one. The device further comprises a device bottom cap which engages a second plunger and a second plunger spring at the second plunger distal end. The second plunger engages a device bottom centering body. The device right side comprises a device right side port. The shuttle piston comprises a shuttle piston left side and shuttle piston right side. A series of components fit into the device right side as follows. A device right side piston cap engages device right side retainer cup, device right side o-ring one, device right side seal, device right side o-ring two, and shuttle piston right side. The device left side piston cap engages a device left side retainer cup, a device left side o-ring one, a device left side seal, a device left side o-ring two and device guide housing.

One or ordinary skill in the art will appreciate that embodiments of the present disclosure may be constructed of materials known to provide, or predictably manufactured to provide the various aspects of the present disclosure. These materials may include, for example, stainless steel, titanium alloy, aluminum alloy, chromium alloy, and other metals or metal alloys. These materials may also include, for example, PEEK, carbon fiber, ABS plastic, polyurethane, rubber, latex, synthetic rubber, and other fiber-encased resinous materials, synthetic materials, polymers, and natural materials. The plunger elements could be semi-rigid or rigid and made of materials such as stainless steel, titanium alloy, aluminum alloy, chromium alloy, and other metals or metal alloys. Similarly, the shuttle piston could be semi-rigid or rigid and made of materials such as stainless steel, titanium alloy, aluminum alloy, chromium alloy, and other metals or metal alloys.

One of ordinary skill in the art will appreciate that embodiments of the present disclosure may be controlled by means other than mechanical and/or hydro-mechanical manipulation. Embodiments of the present disclosure may be designed and shaped such that the apparatus may be controlled, for example, remotely by an operator, remotely by an operator through a computer controller, by an operator using proportioning devices, programmatically by a computer controller, by servo-controlled mechanisms, by pneumatically-driven mechanisms, by piezoelectric actuators or diaphragm mechanisms.

In one embodiment of the invention, the device housing is not of rectilinear geometry, but rather of any geometry that can serve the functions described. For example, the device housing may be of cubic, oval or round geometry.

In another embodiment of the invention, the one or more plungers are not substantially opposite one another. In one embodiment, one plunger is used, either mounted above the shuttle piston or mounted below the shuttle piston.

In another embodiment, the shuttle piston is not axially symmetrical. In one embodiment, the shuttle piston does not engage the one or more plungers symmetrically. In one embodiment, the shuttle piston engages the one or more plungers with a surface that is not substantially conical, but rather any geometrical configuration that allows movement of the one or more plungers due to a selectable pressure difference between the pressurized input fluids. For example, the shape in cross-section could be an arc. Also, the means to engage and move the one or more plungers could be a pivot mechanism. Further, the mechanism or means to move the one or more plungers could be, in other embodiments, can be selected, for example, from the group of the electric-motor, piezoceramic, bimetallic, memory metallic, pneumatic, peristaltic, electrostatic, electromagnetic, and/or thermal drive units.

In one embodiment of the invention, the one or more plungers engage other than a coil-like spring, but instead engage any mechanism that can serve the same function as a coil-like spring. For example, the one or more plungers engage one or more leaf-type springs, flat springs, bow springs, cantilever springs, wave springs, conical springs, V-springs, gas springs, hydraulic springs, pneumatic springs and any elastic objects know to those skilled in the art that function to store and release mechanical energy.

In one embodiment of the invention, the device is fitted with one or more active and/or passive sensors for qualitative and/or quantitative sensing of mechanical, electrical, physical, and/or chemical quantities, to detect, for example, position of the shuttle piston and/other mechanisms and/or pressures of various fluids engaged with the device. Such sensors can be selected in particular from the group of timers, infrared sensors, brightness sensors, temperature sensors, motion sensors, elongation sensors, rotation speed sensors, proximity sensors, flow sensors, color sensors, gas sensors, vibration sensors, pressure sensors, conductivity sensors, turbidity sensors, acoustic pressure sensors, “lab on a chip” sensors, force sensors, acceleration sensors, tilt sensors, pH sensors, moisture sensors, magnetic field sensors, RFID sensors, magnetic field sensors, Hall sensors, biochips, odor sensors, hydrogen sulfide sensors, and/or MEMS sensors, as well as simpler sensors such as a tilt switch, pressure switch, or contact switch.

In another embodiment, flow sensors may be employed from the group of diaphragm flow sensors, magnetic induction flow sensors, mass flow measurement using the Coriolis method, vortex counter flow measurement methods, ultrasonic flow measurement methods, suspended-particle flow measurement, annular-piston flow measurement, thermal mass flow measurement, or effective-pressure flow measurement.

In one embodiment, the sensors are conveyed as control signals to a control unit.

In one embodiment of the invention, the first fluid is a base material and the second fluid is a catalyst material. In another embodiment, the first fluid is a catalyst material and the second fluid is a base material. In one embodiment, one or more of the device right-side port and device left side port are in fluid communication with an air motor.

In another embodiment, the user is alerted to a selectable pressure differential between the first fluid and the second fluid by any means known to those skilled in the art. For example, the alert (or alarm or indication) could be communicated to a user by any one or combination of means, to include audio, vibration, thermal, mechanical such as actuation of a piston or lever, electrical, fluid, pneumatic, visual such as a steady or blinking light, magnetic, hydro-mechanical, and/or electro-mechanical such as through use of piezoelectric transducers, linear variable differential transformers and/or rotary variable differential transformers.

In one embodiment of the invention, the range of nominal pressure of each of the first fluid and the second fluid is preferably between 1 and 5000 psi, more preferably between 100 and 2000 psi, and most preferably between 250 and 1000 psi.

In one embodiment of the invention, the shuttle piston is configured to move within the housing of the device and cause the one or more plungers to move so as to stop the fluid communication of at least one of the third port and fourth ports (e.g., a pneumatic pump) with an external source when a selectable threshold difference in pressure exists between said first and second fluids, the selectable difference in pressure is preferably between 1 and 100 psi, more preferably between 10 and 50 psi, and most preferably between 30 and 50 psi.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claim set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1A is a top-view of the device for preventing improper fluid mixing ratios, and is one of a set of three figures that make-up a 3-view of the device;

FIG. 1B is a front-view of the device for preventing improper fluid mixing ratios, and is one of a set of three figures that make-up a 3-view of the device;

FIG. 1C is a side-view of the device for preventing improper fluid mixing ratios, and is one of a set of three figures that make-up a 3-view of the device;

FIG. 1D is a cross-sectional view of the device shown in FIG. 1B, the cross-sectional taken along plane A-A;

FIG. 1E is a cross-sectional view of the device shown in FIG. 1C, the cross-sectional taken along plane B-B;

FIG. 1F is a cross-sectional view of the device shown in FIG. 1B, the cross-sectional taken along plane A-A, the device in a locked-out configuration;

FIG. 1G is a cross-sectional view of the device shown in FIG. 1C, the cross-sectional taken along plane B-B, the device in a locked-out configuration; and

FIG. 2 is an exploded perspective view of the device of FIGS. 1A-G, showing the relationship between selected elements of the device.

### DETAILED DESCRIPTION

The present invention relates to an apparatus and method for maintaining a fluid mixing ratio. The apparatus according to various embodiments prevents a fluid flow imbalance between two proportionate fluid streams based on a pressure difference, and may be configured to alert the user and/or stop the fluid flow in the event of a fluid flow imbalance. The apparatus is formed such that two plunger components engage a shuttle piston, the shuttle piston configured to move one or more plunger components given a selectable fluid flow imbalance.

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

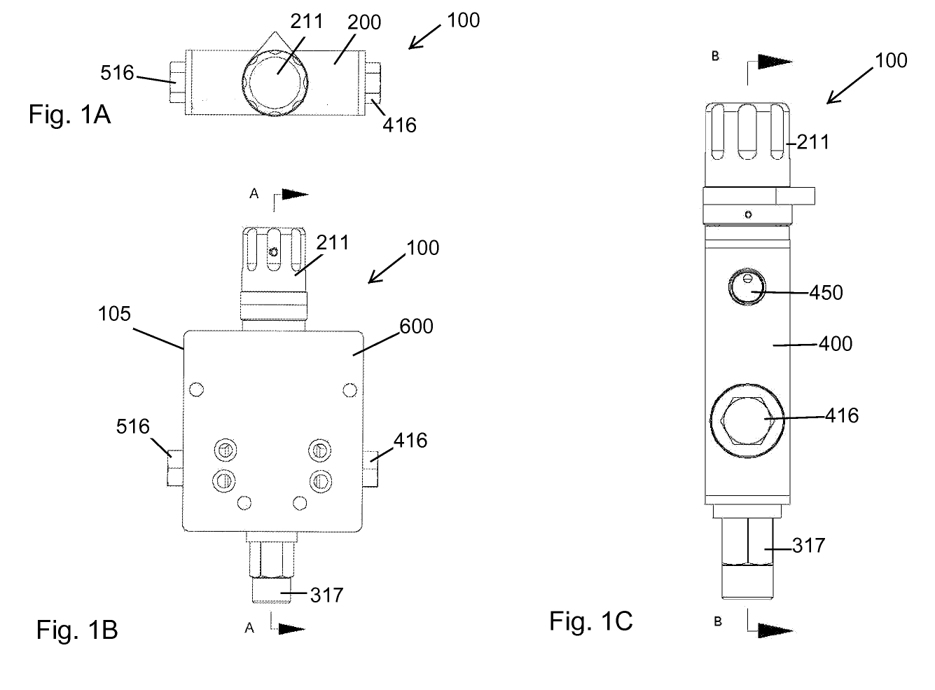

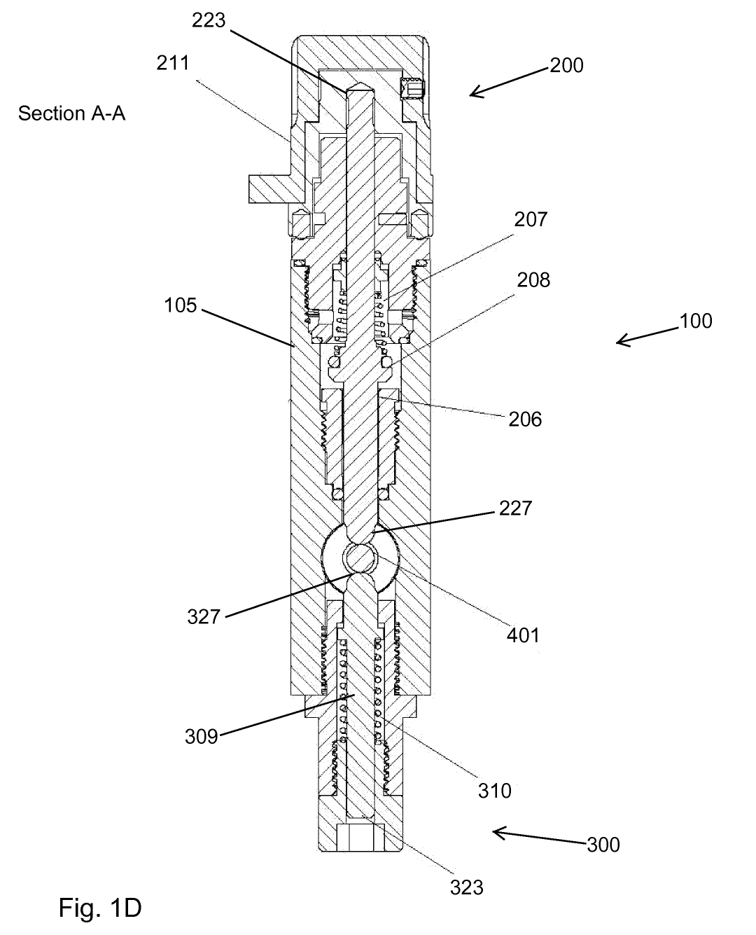

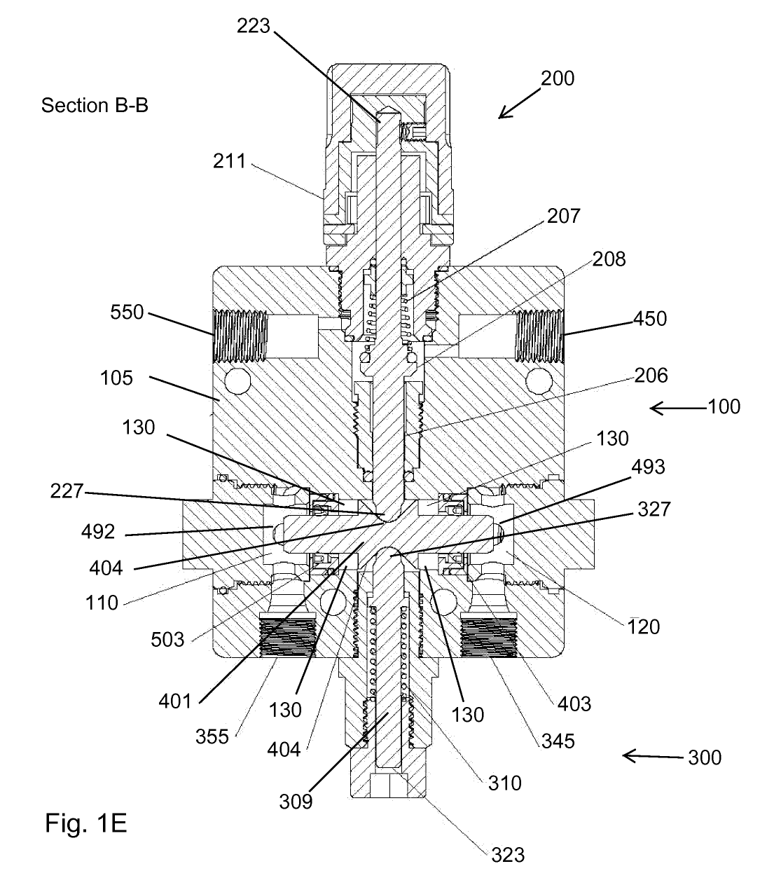

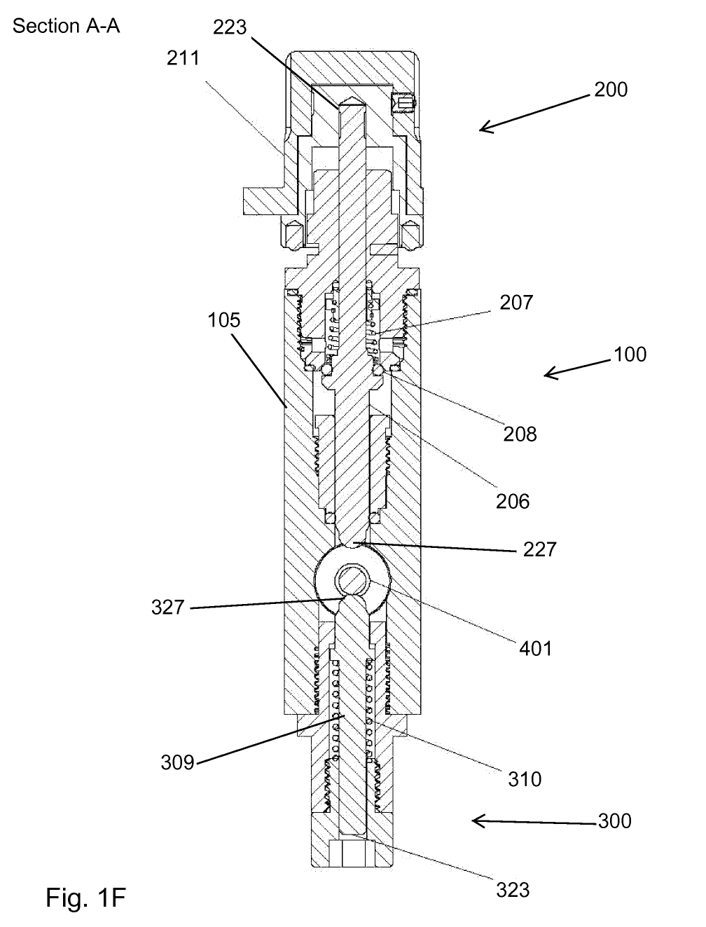

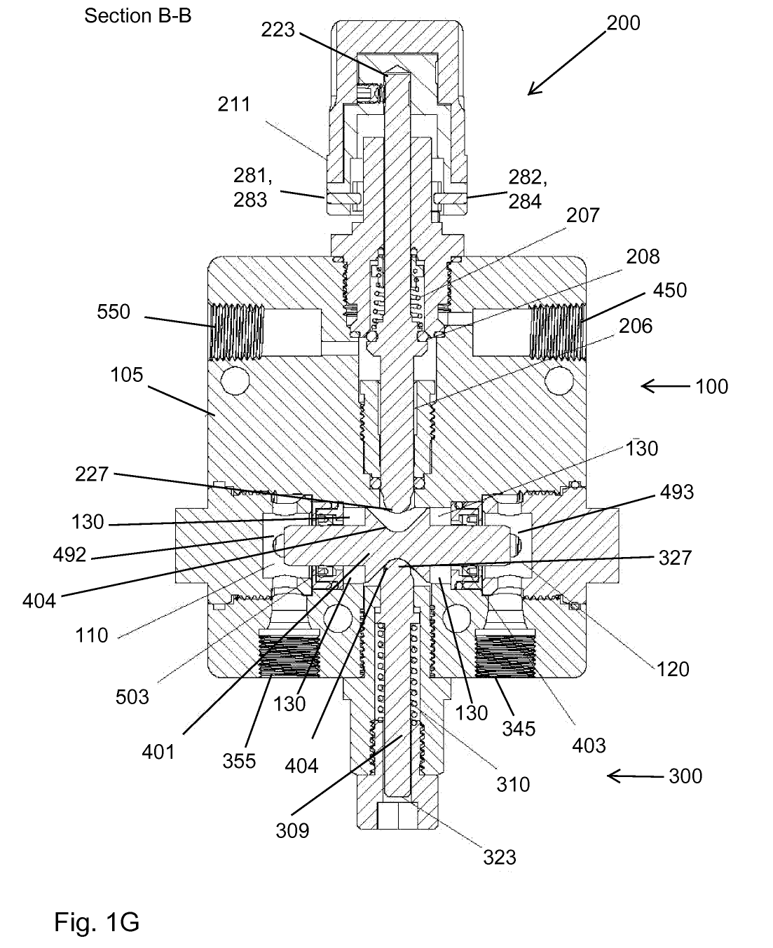

Referring now to FIGS. 1-3, several representations and configurations of the present invention are shown.

In regard to FIGS. 1A-C, a three-view of the device 100 is provided, depicting respective top, front and right-side views. FIG. 1A is a top-view of the device 100 for preventing improper fluid mixing ratios, FIG. 1B is the corresponding front-view and FIG. 1C is the corresponding right-side view.

Referring now to FIG. 1A, the top-view of the device 100 is shown with device top 200, device top upper knob 211, device left side piston cap 516 and device right side piston cap 416.

Referring now to FIG. 1B, the front-view of the device 100 is shown with device face 600, device top upper knob 211, device left side piston cap 516, device right side piston cap 416 and device bottom cap 317. In this embodiment of the device 100, the device 100 comprises a device housing 105 of generally rectilinear geometry.

Referring now to FIG. 1C, the right front-view of the device 100 is shown with device right side 400, device top upper knob 211, device right side piston cap 416, device right side port 450 and device bottom cap 317.

In regard to FIGS. 1D-E, cross-sectional views of the device in a steady-state configuration are shown. The cross-sectional view of FIG. 1D is taken along plane A-A of FIG. 1B. The cross-sectional view of FIG. 1E is taken along plane B-B of FIG. 1C.

Referring now to FIGS. 1D-E, the device 100 is shown comprising device housing 105, device top 200, device top upper knob 211 and device bottom 300. Shown within the device housing 105 of the device 100 are a first plunger 206 and a second plunger 309, each of which are engaged with a shuttle piston 401 at shuttle piston conical section 404. The first plunger 206 includes a first plunger proximal end 227, a first plunger distal end 223 and a poppet air shut-off valve 208. A first plunger 206 axial axis is formed between the first plunger proximal end 227 and first plunger distal end 223. The first plunger 206 is configured to contact a first plunger spring 207, the first plunger spring 207 configured to fit around the exterior of the first plunger 206. In one embodiment of the invention, the first plunger spring 207 is substantially co-axial with the first plunger 206. The first plunger spring 207 is configured to impart a substantially axial force to the first plunger 206 so as to enable substantially constant contact or communication between the first plunger proximal end 227 and the shuttle piston 401 shuttle piston conical section 404. Similarly, the second plunger 309 includes a second plunger proximal end 327 and a second plunger distal end 323. The second plunger 309 is configured to contact a second plunger spring 310, the second plunger spring 310 configured to fit around the exterior of the second plunger 309. In one embodiment of the invention, the second plunger spring 310 is substantially co-axial with the second plunger 309. A second plunger 309 axial axis is formed between the second plunger proximal end 327 and second plunger distal end 323. The second plunger spring 310 is configured to impart a substantially axial force to the second plunger 309 so as to enable substantially constant contact or communication between the second plunger proximal end 327 and the shuttle piston 401 at the shuttle piston conical section 404. In one embodiment of the invention, the first plunger 206 and a second plunger 309 are substantially coaxial. The shuttle piston conical section 404 is symmetrical about a plane perpendicular to the midpoint of the axial centerline of the shuttle piston 401.

In the embodiment of the invention of FIGS. 1D-E, the shuttle piston 401 operates along an axis that is substantially perpendicular to at least one of the operating axis of first plunger 206 and second plunger 309. A shuttle piston 401 axial axis is formed between the shuttle piston left side 492 and shuttle piston right side 493. The shuttle piston 401 operates within a cylindrical bore contained within the device housing 105, with device right side seal 403 and device left side seal 503, therein forming two adjacent chambers, device right side chamber 120 and device left side chamber 110 that may be pressurized. The shuttle piston left side 492 substantially resides in the device left side chamber 110, and the shuttle piston right side 493 substantially resides in the device right side chamber 120. The device 100 also comprises unpressurized cavities 130 adjacent to the shuttle piston 401. The shuttle piston 401 is thus configured to move axially.

Each of the first plunger 206 and second plunger 309 are able to move along their respective axial axes. When the first plunger 206 moves vertically upwards toward the device top 200, the first plunger spring 207 imparts an opposing force that urges the first plunger 206 in the opposite direction, that is, downward and toward the shuttle piston 401. In contrast, when the second plunger 309 moves vertically downwards toward the device bottom 300, the second plunger spring 310 imparts an opposing force that urges the second plunger 309 in the opposite direction, that is, upward and toward the shuttle piston 401.

When the shuttle piston 401 moves along its axial axis from its steady state and/or centered nominal position, either toward the device left side chamber 110 or toward the device right side chamber 120, one or more of first plunger 206 and second plunger 309 move vertically away from the shuttle piston 401 as each of the first plunger 206 and second plunger 309 engage a section of the shuttle piston conical section 404 of increased radius. Stated another way, a hemispherical first plunder proximal end 227 engages the upper shuttle piston conical section 404 of the shuttle piston 401 such that any movement of the shuttle piston 401 along its longitudinal (axial) axis in either direction will cause the first plunger 206 to rise along the surface of the upper conical section 404 and be forced away from the longitudinal (axial) axis of the shuttle piston 401. The rate and magnitude of this movement can be changed as desired by modifying the included angle and diameter of the conical section 404 of the shuttle piston 401. Further, the movement of the first plunger 206 can be utilized to actuate a valve or switch to alert the operator user or to stop the equipment upstream and/or downstream of the device 100.

A poppet-style (and/or mushroom-style) air shut-off valve 208 is formed as a part of the first plunger 206 such that axial movement of the shuttle piston 401 due to a pressure differential between device right-side chamber 120 and device left-side chamber 110 is sufficient to move the first plunger 206 and cause the poppet air shut-off valve 208 to close. The poppet air shut-off valve 208 is in-line with the one or more of device right-side port 450 and device left-side port 550. Therefore, when the poppet air shut-off valve 208 closes, the first air pressure and the second air pressure of the respective device right side port 450 and device left side port 550 are no longer equal, the two ports are no longer in fluid communication and the air flow stops, thus causing the motor to stop. When the poppet air shut-off valve 208 moves to its closed position, the inlet air pressure (from one or more of device right-side port 450 and/or device left-side port 550) exerts enough force on the bottom of the poppet air shut-off valve 208 that the poppet air shut-off valve 208 will remain closed until the poppet air shut-off valve 208 is manually reset by a user. The poppet air shut-off valve 208 may be manually reset through engagement of the device top upper knob 211, for example, by pushing the device top upper know vertically downwards.

The second plunger 309, diametrically opposed to the first plunger 206 along the shuttle piston 401, creates additional centering force to the shuttle piston 201 thereby further resisting axial (that is, longitudinal) movement of the shuttle piston 401, in turn increasing the threshold value of pressure differential between device left-side chamber 110 and device right-side chamber 120 below which the shuttle piston 401 will not move. This threshold value is established by the combined spring force applied to the first plunger 206 and the second plunger 309 and the diameter of the shuttle piston 401.

Generally, the device 100 is in fluid communication with a first fluid through device bottom right side pressure port 345 and a second fluid through device left side pressure port 355. The first fluid maintains a nominal pressure one or first pressure, and the second fluid maintains a nominal pressure two or second pressure. The nominal pressure maintained in device right side chamber 120, which is in fluid communication with first fluid, is the same as that of first fluid. Similarly, the nominal pressure maintained in device left side chamber 110, which is in fluid communication with the second fluid, is the same as that of second fluid. When in steady-state and/or nominal operation, the first fluid and the second fluid are at substantially the same pressure, and thus each of the device right side chamber 120 and the device left side chamber 110 are at the same pressure and exert a substantially equal and opposite force against the shuttle piston right side 493 and the shuttle piston left side 492, respectively, and the shuttle piston 401 maintains a centered or nominal position substantially centered about the device 100 vertical centerline and each of the first plunger 206 and second plunger 309 maintain a nominal position, as shown in FIGS. 1D-E. However, when a predetermined and selectable pressure differential between the first fluid and the second fluid exists (and thus a pressure differential exists between the device right side chamber 120 and the device left side chamber 110), the shuttle piston 401 will traverse along its axial axis, which in turn will move the respective proximal ends of each of first plunger 206 and second plunger 309 vertically and away from the center area of the device 100 as described above. The vertical movement of the first plunger 206 and second plunger 309 provide a means to alert the user and/or stop the fluid flow of the fluid flow imbalance event.

Also shown in FIG. 1E is the device 100 with device right side port 450 and device left side port 550. In the embodiment of FIG. 1E, one or more of the device right side port 450 and device left side port 550 are in communication with an air motor. The device right side port 450 provides a first air pressure and the device left side port 550 provides a second air pressure. During nominal or steady-state operation, the first air pressure and the second air pressure are substantially equal and the device right side port 450 and device left side port 550 are in fluid communication.

In regard to FIGS. 1F-G, cross-sectional views of the device in a locked-out state configuration are shown. This locked-out state is particularly useful to prevent unwanted actuation of the poppet air shut-off valve 208 and subsequent stoppage of external equipment during operational modes. The locked-out state would be useful during, for example, pump priming or system flushing or any situation that requires or causes unbalanced pressure between the two to-be-mixed fluids (such as a base and catalyst).

The cross-sectional view of FIG. 1F is taken along plane A-A of FIG. 1B. The cross-sectional view of FIG. 1G is taken along plane B-B of FIG. 1C.

Referring now to FIGS. 1F-G, the device 100 is shown comprising device housing 105, device top 200, device top upper knob 211 and device bottom 300. Shown within the device housing 105 of the device 100 are a first plunger 206 and a second plunger 309, each of which are engaged with a shuttle piston 401 at shuttle piston conical section 404. The first plunger 206 includes a first plunger proximal end 227, a first plunger distal end 223 and a poppet air shut-off valve 208. A first plunger 206 axial axis is formed between the first plunger proximal end 227 and first plunger distal end 223. The first plunger 206 is configured to contact a first plunger spring 207, the first plunger spring 207 configured to fit around the exterior of the first plunger 206. In one embodiment of the invention, the first plunger spring 207 is substantially co-axial with the first plunger 206. The first plunger spring 207 is configured to impart a substantially axial force to the first plunger 206 so as to enable substantially constant contact or communication between the first plunger proximal end 227 and the shuttle piston 401 shuttle piston conical section 404. Similarly, the second plunger 309 includes a second plunger proximal end 327 and a second plunger distal end 323. The second plunger 309 is configured to contact a second plunger spring 310, the second plunger spring 310 configured to fit around the exterior of the second plunger 309. In one embodiment of the invention, the second plunger spring 310 is substantially co-axial with the second plunger 309. A second plunger 309 axial axis is formed between the second plunger proximal end 327 and second plunger distal end 323. The second plunger spring 309 is configured to impart a substantially axial force to the second plunger 309 so as to enable substantially constant contact or communication between the second plunger proximal end 327 and the shuttle piston 401 at the shuttle piston conical section 404. In one embodiment of the invention, the first plunger 206 and a second plunger 309 are substantially coaxial. The shuttle piston conical section 404 is symmetrical about a plane perpendicular to the midpoint of the axial centerline of the shuttle piston 401.

In the embodiment of the invention of FIGS. 1F-G, the shuttle piston 401 operates along an axis that is substantially perpendicular to at least one of the operating axis of first plunger 206 and second plunger 309. A shuttle piston 401 axial axis is formed between the shuttle piston left side 492 and shuttle piston right side 493. The shuttle piston 401 operates within a cylindrical bore contained within the device housing 105, with device right side seal 403 and device left side seal 503, therein forming two adjacent chambers, device right side chamber 120 and device left side chamber 110 that may be pressurized. The shuttle piston left side 492 substantially resides in the device left side chamber 110, and the shuttle piston right side 493 substantially resides in the device right side chamber 120. The device 100 also comprises unpressurized cavities 130 adjacent to the shuttle piston 401. The shuttle piston 401 is thus configured to move axially.

A poppet-style (and/or mushroom-style) air shut-off valve 208 is formed as a part of the first plunger 206 such that axial movement of the shuttle piston 401 due to a pressure differential between device right-side chamber 120 and device left-side chamber 110 is sufficient to move the first plunger 206 and cause the poppet air shut-off valve 208 to close. The poppet air shut-off valve 208 is in-line with the one or more of device right-side port 450 and device left-side port 550. Therefore, when the poppet air shut-off valve 208 closes, the first air pressure and the second air pressure of the respective device right side port 450 and device left side port 550 are no longer equal, the two ports are no longer in fluid communication and the air flow stops, thus causing the motor to stop. When the poppet air shut-off valve 208 moves to its closed position, the inlet air pressure (from one or more of device right-side port 450 and/or device left-side port 550) exerts enough force on the bottom of the poppet air shut-off valve 208 that the poppet air shut-off valve 208 will remain closed until the poppet air shut-off valve 208 is manually reset by a user. The poppet air shut-off valve 208 may be manually reset through engagement of the device top upper knob 211, for example, by pushing the device top upper know vertically downwards. In the configuration of the device 100 as shown by FIGS. 1F-G, the device 100 is in the locked-out state in that the poppet air shut-off valve 208 is stopping flow between device right-side port 450 and device left-side port 550 and one or more of the device top pin one 281 and device top pin two 282 prevent movement of first plunger 206 and lock the first plunger 206 such that the first plunger 206 is not engaged with the shuttle piston 401. In this condition, the fluid pressures from device right side pressure port 345 and device left side pressure port 355 are not subject to monitoring by the device 100. This state is a transitory state, that is, not a steady state, and is useful, for example, during start-up, shut-down, maintenance, cleaning and calibration.

Device top pin one 281 fits into device top pin one receiving hole 283 and device top pin two 282 fits into device top pin receiving hole 284.

Also shown in FIG. 1G is the device 100 with device right side port 450 and device left side port 550. In the embodiment of FIG. 1G, one or more of the device right side port 450 and device left side port 550 are in communication with an external motor, such as an air (pneumatic) motor. The device right side port 450 provides a first air pressure and the device left side port 550 provides a second air pressure.

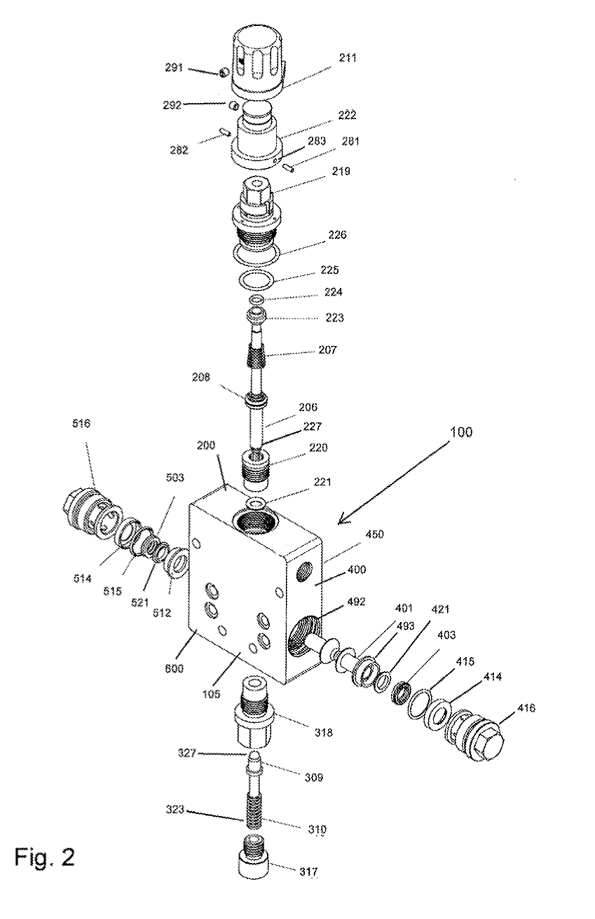

In regard to FIG. 2, an exploded perspective view of the device of FIGS. 1A-G, showing the relationship between the component portions of the device, is provided. In this embodiment, the device 100 comprises a device housing 105 of generally rectilinear geometry, a device top 200, device face 600 and device right side 400.

The device 200 in FIG. 2 is shown with a sequence of components that fit through and/engage the device top 200. A device top upper knob 211 engages a device top lower body knob 222 and a device top upper set screw 291. The device top lower body knob 222 engages a device top lower set screw 292. The device top lower body knob 222 also engages a device top pin one 281 which fits into a device top pin one receiving hole 283, and a device top pin two 282 which fits into a device top pin two receiving hole 284. The device top lower body knob 222 engages an air valve body 219, which in turn engages a device top o-ring four 226, a device top o-ring three 225 and device top o-ring two 224. The air valve body 219 and o-rings 226, 225 and 224 engage the first plunger distal end 223. Below, or nearer the device housing 105, a first plunger spring 207 fits over the first plunger 206. The first plunger 206 comprises a poppet air shut-off valve 208 and a first plunger proximal end 227. The first plunger proximal end 227 engages a poppet guide 220. The poppet guide 220 engages a device top o-ring one 221.

The device 200, as shown in FIG. 2, further comprises a device bottom cap 317 which engages a second plunger 309 and a second plunger spring 310 at the second plunger distal end 323. The second plunger 309 engages a device bottom centering body 318. The device right side 400 comprises a device right side port 450. The shuttle piston 401 comprises a shuttle piston left side 492 and shuttle piston right side 493. A series of components fit into the device right side 400 as follows. A device right side piston cap 416 engages device right side retainer cup 414, device right side o-ring one 415, device right side seal 403, device right side o-ring two 421, and shuttle piston right side 493. The device left side piston cap 516 engages a device left side retainer cup 514, a device left side o-ring one 515, a device left side seal 503, a device left side o-ring two 521 and device guide housing 512.

To provide further clarity to the Detailed Description provided herein in the associated drawings, the following list of components and associated numbering are provided as follows:

REFERENCE NO. COMPONENT

100 Device

105 Device Housing

110 Device Left Side Chamber

120 Device Right Side Chamber

130 Device Unpressurized Cavities

200 Device Top

206 First Plunger

207 First Plunger Spring

208 Poppet Air Shut-off Valve

211 Device Top Upper Knob

219 Air Valve Body

220 Poppet Guide

221 Device Top 0-Ring One

222 Device Top Lower Body Knob

223 First Plunger Distal End

224 Device Top 0-Ring Two

225 Device Top 0-Ring Three

226 Device Top 0-Ring Four

227 First Plunger Proximal End

281 Device Top Pin One

282 Device Top Pin Two

283 Device Top Pin One Receiving Hole

284 Device Top Pin Two Receiving Hole

291 Device Top Upper Set Screw

292 Device Top Lower Set Screw

300 Device Bottom

309 Second Plunger

310 Second Plunger Spring

317 Device Bottom Cap

318 Device Bottom Centering Body

323 Second Plunger Distal End

327 Second Plunger Proximal End

345 Device Bottom Right Side Pressure Port

355 Device Bottom Left Side Pressure Port

400 Device Right Side

401 Shuttle Piston

403 Device Right Side Seal

404 Shuttle Piston Conical Section

414 Device Right Side Retainer Cup

415 Device Right Side 0-Ring One

416 Device Right Side Piston Cap

421 Device Right Side 0-Ring Two

450 Device Right Side Port

492 Shuttle Piston Left Side

493 Shuttle Piston Right Side

500 Device Left Side

503 Device Left Side Seal

512 Device Guide Housing

514 Device Left Side Retainer Cup

515 Device Left Side 0-Ring One

516 Device Left Side Piston Cap

521 Device Left Side 0-Ring Two

550 Device Left Side Port

600 Device Face

700 Device Back

While various embodiment of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A fluid control device, comprising:
a housing having a plurality of ports, a central chamber, at least one plunger and a shuttle piston;
wherein at least one of said plurality of ports is a first port adapted to receive a first fluid at a first fluid pressure and at least one of said plurality of ports is a second port adapted to receive a second fluid at a second fluid pressure;
wherein said at least one plunger has a distal end and a proximal end, wherein said proximal end is configured to engage said shuttle piston;
wherein said shuttle piston is adapted to be in fluid communication with said first fluid and said second fluid;
wherein said shuttle piston is configured to move within said housing when a first selectable difference in pressure exists between said first and second fluids;
wherein upon movement of said shuttle piston, said at least one plunger moves so as to provide an indication that a selectable difference in pressure exists between said first and second fluids.

2. The device of claim 1, wherein said at least one plunger comprises a poppet valve.

3. The device of claim 2, wherein said housing further comprises a third port and a fourth port, said third port and fourth ports in fluid communication with an external source.

4. The device of claim 3, wherein when a selectable threshold difference in pressure exists between said first and second fluids, said poppet valve substantially stops said fluid communication of at least one of said third port and fourth ports with said external source.

5. The device of claim 4, wherein said external source is a pneumatic pump.

6. The device of claim 1, wherein said shuttle piston is configured with a conical section, said conical section engaging said at least one plunger.

7. The device of claim 1, wherein said at least one plunger comprise a first plunger and a second plunger.

8. The device of claim 7, wherein said first plunger is configured to operate substantially opposite to said second plunger.

9. The device of claim 1, wherein said housing is formed of a metallic material.

10. The device of claim 1, wherein said first fluid comprises a base material and a catalyst material, and said second fluid comprises a base material and a catalyst material.

11. The device of claim 1, wherein said indication is selected from the group consisting of audio alarms, visual alarms, vibration alarms, mechanical alarms, electrical alarms, fluid alarms, thermal alarms, electro-mechanical alarms, hydro-mechanical alarms and pneumatic alarms.

12. A method of monitoring fluid mixing ratios comprising:
attaching a device to receive a first fluid at a first fluid pressure and a second fluid at a second pressure, said device comprising:
a housing having a plurality of ports, a central chamber, at least one plunger and a shuttle piston;
wherein at least one of said plurality of ports is a first port adapted to receive a first fluid at a first fluid pressure and at least one of said plurality of ports is a second port adapted to receive a second fluid at a second fluid pressure;
wherein said at least one plunger has a distal end and a proximal end, wherein said proximal end is configured to engage said shuttle piston;
wherein said shuttle piston is adapted to be in fluid communication with said first fluid and said second fluid;
wherein said shuttle piston is configured to move within said housing when a first selectable difference in pressure exists between said first and second fluids;
wherein upon movement of said shuttle piston, said at least one plunger moves so as to provide an indication that a selectable difference in pressure exists between said first and second fluids.

13. The method of claim 12, wherein said at least one plunger comprises a poppet valve.

14. The method of claim 13, wherein said housing further comprises a third port and a fourth port, said third port and fourth ports in fluid communication with an external source at a third fluid pressure.

15. The method of claim 14, wherein when a selectable threshold difference in pressure exists between said first and second fluids, said poppet valve substantially stops said fluid communication of at least one of said third port and fourth ports with said external source.

16. The method of claim 15, wherein said external source is a pneumatic pump.

17. The method of claim 12, wherein said shuttle piston is configured with a conical section, said conical section engaging said at least one plungers.

18. The method of claim 12, wherein said one or more plungers comprise a first plunger and a second plunger.

19. The method of claim 18, wherein said first plunger is configured to operate substantially opposite to said second plunger.

20. The method of claim 12, wherein said first fluid comprises a base material and a catalyst material, and said second fluid comprises a base material and a catalyst material.
